(19) United States
(12) Patent Application Publication
(10) Pub. No.: US 2006/0226190 A1
(43) Pub. Date: Oct. 12, 2006

(54) Hope walking pouch

(76) Inventor: Gwendolyn Norrington Green, Oxford, GA (US)

Correspondence Address: Gwendolyn Norrington Green, P. O. Box 491, Oxford, GA, 30054, US

(21) Appl. No.: 11/103,269

(22) Filed: Apr. 12, 2005

(51) Int. Cl. B60R 7/00; B60R 9/00

(52) U.S. Cl. 224/407

(57) ABSTRACT

The walking stick is to offer weight support while walking. The improved walking stick has a pouch added. The pouch slide over the walking stick. The pouch fastens with a two inch wide clamp at the top of the stick and a two inch clamp at the bottom of the stick. The pouch has three pockets sewn inside that holds small items and a zipper that open from the top to bottom and wire on each side of the zipper this gives it a easy closure and better structure form. With the pouch you will still be able to adjust the stick to your proper height. The usefulness of this pouch will let you no longer have to hassle with your pocketbook or bag to keep up with when walking. This advantage is an improvement.

The present invention of the walking stick does not have a place to store small items as a Sectional pocketbook. The new and improve pouch added to the walking stick provide space to carry small items same as a pocketbook. The Hope Walking pouch is a two-in-one, a walking stick for support and a pouch used same as pocketbook or carrying bag. You have only one item to keep up with. The pouch added fulfills the need to have one item and that solves the problem. You will be free are so much to keep up with. The pouch is made with a black vinyl material, width 12 inch and length 31½ inch. The size of the strips of material for pockets each 8 inch×12. The heavy weight zipper length is 30 inches long, two 18 gauge wire is 30 inch long for each side of zipper. String size for handle is a 6 inch loop. Walking stick the pouch slides over is 34 to 39 inches long. And there are two clamps that are 2 inches wide each for the top and the bottom are the pouch.

### DRAWINGS

FIG. 1 is vinyl material cut in the size of width 12 inch and length 31½ inches.

FIG. 2 is three clear vinyl strips of material size 8 inch×12 each for three inside pockets

FIG. 3 is a view with three clear vinyl strips of material sewn down on to the 12 inch width by 31½ inch size vinyl material, note there is a 1 inch space between the bottom pocket and the middle pocket. A ½ inch space between the middle pockets and a ½° inch between the top pockets. The top pocket has a top space of 4 inches from the top of the material.

FIG. 4 is the heavy weight 30 inch zipper that separate from the bottom

FIG. 5 is the heavy weight zipper separated on each side of the vinyl material one side of the zipper stitch on left side of material and one side of zipper stitch on right side

FIG. 6 is the 18 inch gauge wire.

FIG. 7 is a view of the 18 inch gauge wire for right side support and left side support. Next to the right the zipper is a ½ inch seam, the seam length is 30 inches the same as the zipper. Slide the 18 inch gauge wire through the seam right next to the side of the zipper.

FIG. 8 is a view of the vinyl material with one side of zipper sewn on each side of material, and the 18 inch gauge wire is inserted up the small seam next to the zipper. Bring the left side zipper and right side zipper together, zip both sides together this will close the zipper.

FIG. 9 is a large opening at the tube top and bottom with the zipper closed. It is now named a pouch.

FIG. 10 is a view of the present invention the walking stick.

FIG. 11 is a front view is FIG. 9 the pouch, slide the pouch over FIG. 10 the walking stick

FIG. 12 is a view of a 6 inch loop string for storage it can be used around wrist to keep from dropping when walking.

FIG. 13 is two 2 inch wide clamps

FIG. 14 is a view of the pouch slipped over the walking stick over the walking stick, gather together the pouch at the top take one 2 inch clamp, and place it around both the top of the pouch and top of the walking stick. Tightly bind both the pouch and walking stick together, with the zipper side to the back of the stick.

FIG. 15 is a view of the pouch slipped over the walking stick take the second 2 inch clamp place it around both the bottom of the pouch and bottom of the walking stick, tightly bind the bottom clamp around pouch with the walking stick in center.

FIG. 16 is a view that shows every part assembled, the zipper is open and you can clearly see inside are the pouch the three separate pockets, that can carry many small items.

FIG. 17 is a view that shows the easy to reach adjustment level on the walking stick even with the improve pouch you can still adjust to desired height.

FIG. 18 is a close view of the front of the pouch, clamped tightly to the walking stick, which gives it an elegant structure form with a final finishing view.

FIG. 19 is a left side view that has a slender look.

FIG. 20 is a right side view that has a slender look.

FIG. 21 is a view of the back side of the Hope walking pouch the top 2 inch clamp can be seen and the bottom 2 inch clamp can easily be seen.

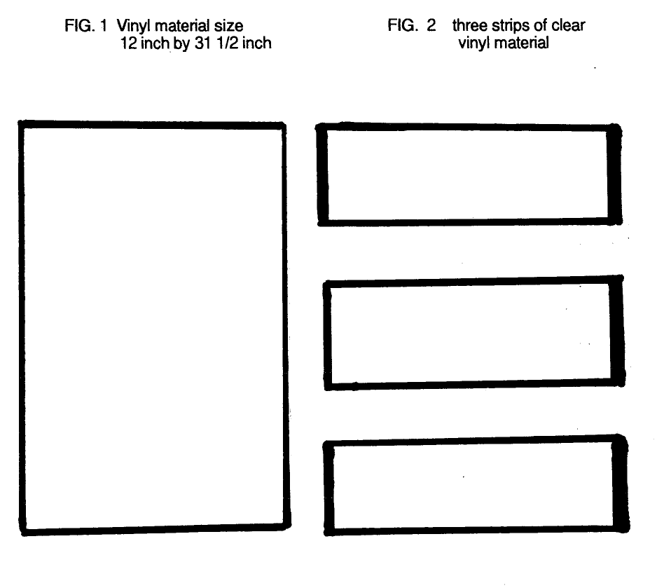

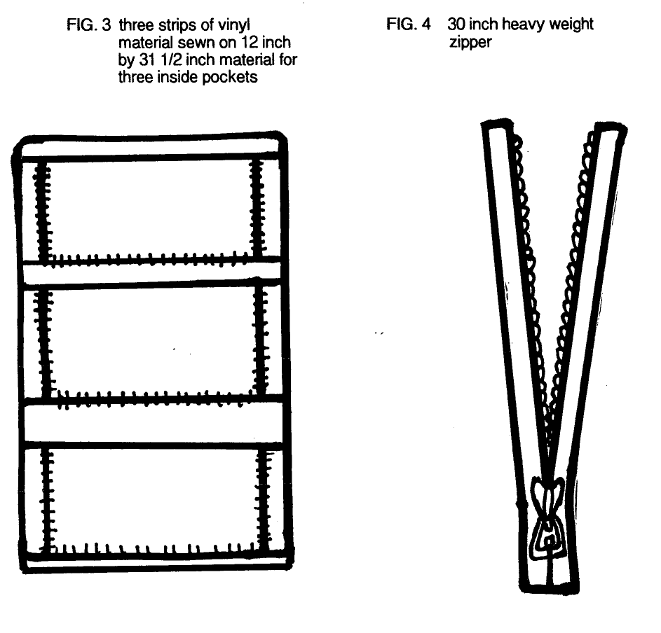

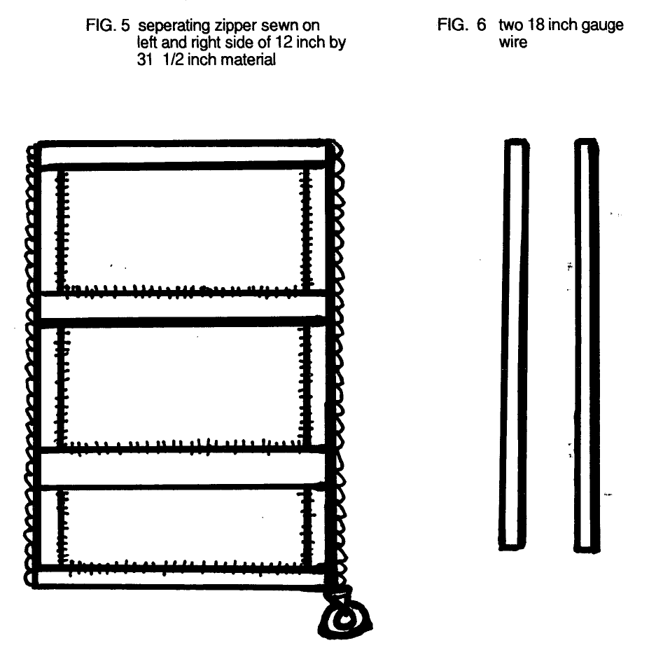

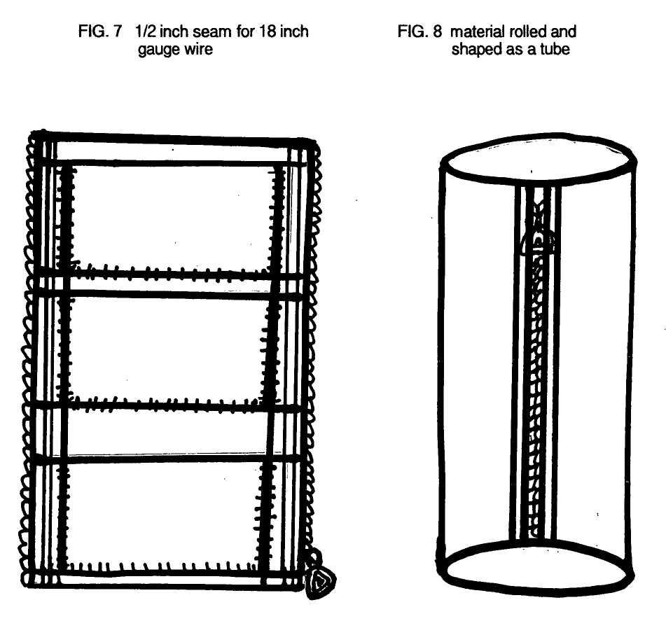

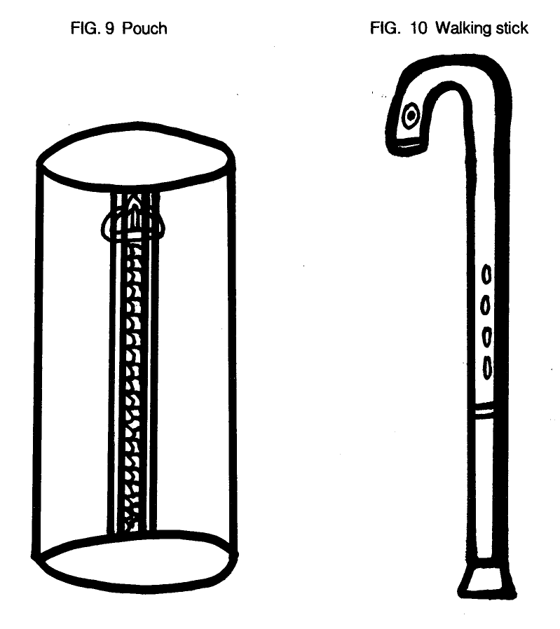

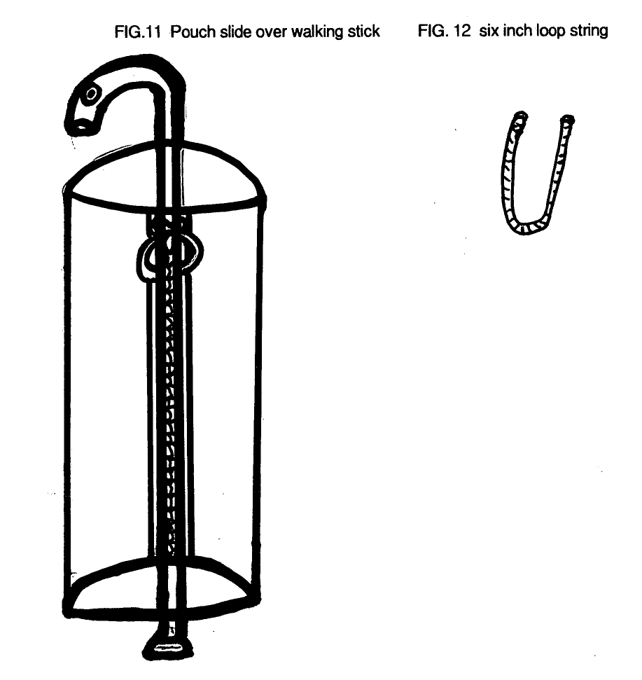

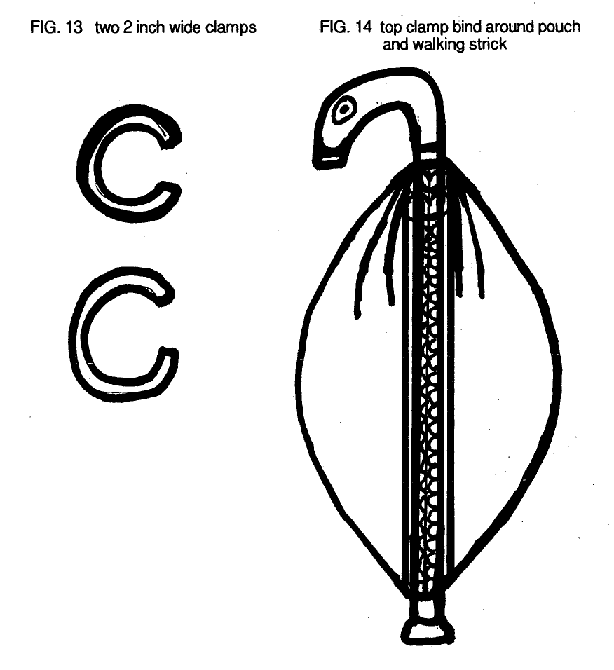

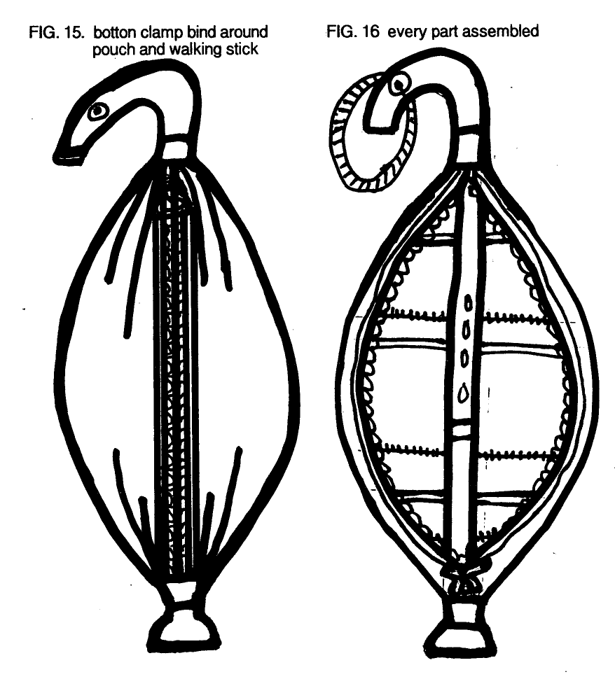

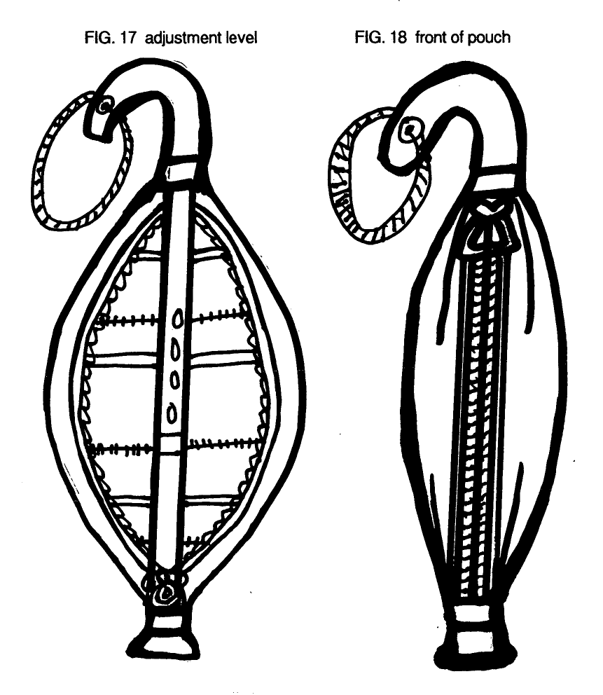

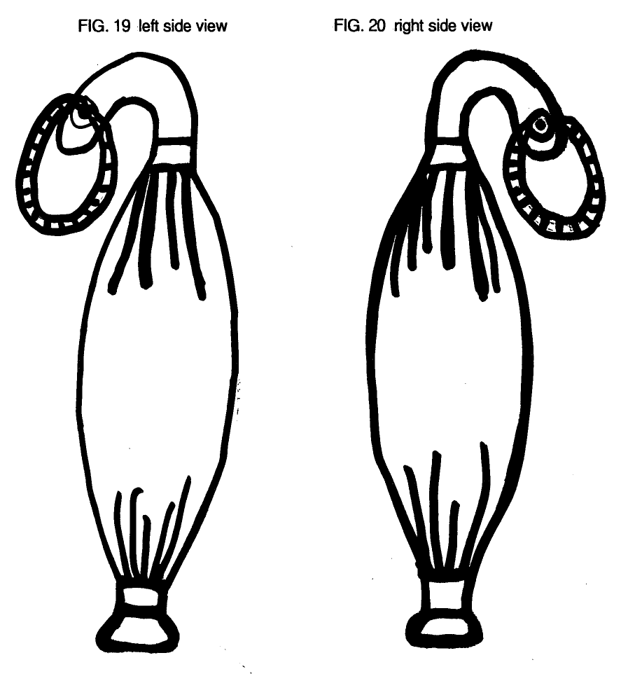

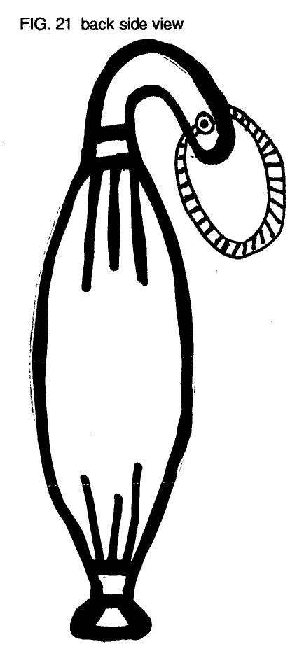

What I claim as my invention is:

1. Name: Hope Walking Pouch
A pouch made to fit on a walking stick, with the length or the pouch the straight of the Stick
Hope walking pouch is only one single item
Know need to carry a pocketbook, the made on pouch have advantage over a pocketbook with it slender look and great convenience,
Hope walking pouch can carry small items (keys, small purse, medicine, crackers, and cell phone) etc.
Looks like an umbrella (lovely, elegant and graceful). The purpose is to cut down on carrying so much around with you to keep up with.
Carry String goes around your wrist for safety and you may hang it up.
Male and Female (unisexual) use.
Old and young use.
Vinyl easy to keep clean.
Pouch can be made out of cloth material, and walking stick still will be light to carry
Comes in every color in the rainbow
Heavy weight zipper much easy to stay on track with wire support on each side for a more easy closure and better structure form.
Walking stick is for support and walking pouch is for convenience
Walking stick also can be adjusted inside, with the new and useful improvement or the pouch
Hope walking pouch comes in permanent heights, short, medium and long size
The size of the black vinyl material width 12 inches, length 31½ inches.
The size of the strips of material each is 8 inches×12
Heavy weight zipper length 30 inches
Wire length 30 inches, wire size 18 gauge
string size 6 inch loops, walking stick height 34 to 39 inches
The Pouch added to the walking stick, give it a new inventive, new fashioned, unique, unusual, different, out of the ordinary and extraordinary look.
